(19) United States
(12) Patent Application Publication
(10) Pub. No.: US 2023/0183600 A1
(43) Pub. Date: Jun. 15, 2023

(54) METHOD FOR PRODUCING FISH OIL

(71) Applicant: MPF, INC., Kensington, NH (US)

(72) Inventors: Stanley H. Hultin, Kensington, NH (US); Hordur G. Kristinsson, Kensington, NH (US); Yong Liang, Kensignton, NH (US)

(73) Assignee: MPF, Inc., Kensington, NH (US)

(21) Appl. No.: 17/924,886

(22) PCT Filed: May 12, 2021
(86) PCT No.: PCT/US21/32015

§ 371 Date: Nov. 11, 2022

Related U.S. Application Data
(60) Provisional application No. 63/023,642, filed on May 12, 2020.

(51) Int. Cl. C11B 1/10; C11B 3/06; C11B 3/04

(52) U.S. Cl. CPC C11B 1/10; C11B 3/06; C11B 3/04

(57) ABSTRACT

A method of extracting oil from biological raw material includes creating a slurry of biological raw material, raising or lowering a pH of the slurry to separate lipid and protein components in the slurry, further separating the lipid and protein components into a first lipid rich phase and a protein rich phase, adjusting a pH of the first lipid rich phase to a point at which additional proteins in the first lipid rich phase coagulate, and recovering a second lipid rich phase from the additional coagulated proteins.

### FIELD

This application relates to new methods to produce high quality minimally processed natural oils and proteins from any raw material of aquatic origin.

### BACKGROUND

There are significant amounts of fat and protein rich byproduct materials that get either wasted or used for low value applications. These include, but are not limited to, fresh and/or frozen trimmings, frames, heads, viscera, guts, livers etc. from a variety of species, for example wild and aquacultured salmon, trout, tuna, whiting, cod and pollock. There is also a large volume of fish species harvested that are rich in proteins and fats that get directed whole to either animal feed or low value human food applications. These include, but are not limited to, capelin, sardines, herring, mackerel, menhaden and anchovies. The process can also be applied to any oil and protein containing biological raw material of animal, plant or microbial origin, including, but not limited to crustaceans, mollusks, echinoderms, land animals (and their products), avian animals (and their products), insects, plants (and their products), fungi, bacteria, plankton, microalgae, macroalgae etc. Furthermore, the process can be applied to already extracted oil from the above sources to improve its quality and stability. In addition, the process can be applied to mildly and efficiently separate any immiscible components coming from the above raw material sources.

A significant amount of the above raw materials and species are used to produce fish meal and fish oil, mainly for animal and aquaculture feed applications. A smaller part of these raw materials and species are used to produce oils (mainly refined and stabilized) for human consumption but very little protein for human consumption. The reasons are the harsh processing methods which are currently available to process these raw materials and species. The crude processing methods render the protein unsuitable for human consumption and make the oils highly unstable which is why they need to be heavily refined and stabilized.

For example, fishmeal and fish oil processes apply very high heat and long processing times which negatively impact the protein, making them lose their functionality as well as develop undesirable off-flavors and odors. During this harsh process, the oils being extracted can become heavily oxidized as well as chemically degraded causing strong undesirable off-odors and flavors. Therefore, they require the use of extensive refining and stabilizing processes. Conventional fishmeal and fish oil processes are also highly capital intensive and only economically feasible for very large volumes of raw materials.

Another recent process of extracting oils is through enzymatic hydrolysis. While this process is milder than conventional fishmeal and fish oil processes, it still involves elevated temperatures and requires long process times for the enzymatic hydrolysis reaction and inactivation. A major drawback of the enzymatic hydrolysis method is the need to process large volumes of material which leads to high enzyme costs as well as energy costs. The long process times and high temperatures used causes degradation of the extracted oil, in a similar way as conventional fishmeal and fish oil processes. Furthermore, this process hydrolyzes the proteins which completely changes their functional properties and significantly limits their use as ingredients for food products. For example, the hydrolyzed proteins have a strong bitter flavor which limits their use in consumer products. Also, for example, the enzymatic hydrolysis process breaks down the protein structure which makes them unable to be used to create structured products such as fish patties and gels.

### SUMMARY

The disclosure described herein provides for a new method of efficiently extracting oils and fish proteins from any raw material of aquatic origin by means of a unique pH shift technique where oil/fat is separated from the proteins in the raw material. The process is not just limited to aquatic raw materials but can also be used to efficiently extract oil and proteins from any biological raw material of animal, plant or microbial origin. Furthermore, the process can be applied to separate any immiscible components coming from any biological raw material of animal, plant or microbial origin. The process recovers natural minimally processed virgin oils with higher stability and quality than oils made with other current processes and at higher yields. Furthermore, the proteins recovered are of unparalleled quality and stability compared to proteins recovered with other current processes. The unique, mild process uses lower temperatures than other commercial processes and also has shorter processing time, and therefore, results in higher quality oils and proteins of human grade, but that can equally be used for feed and pet food applications. The process can be performed either as a continuous or batch operation. A significant benefit of the process is lower operating costs compared to enzymatic hydrolysis processing and other conventional fishmeal and fish oil processes. A significant benefit of the process is its ability to not only use fresh raw materials but also frozen raw materials and produce high yields of oils of unparallel quality and stability compared to other existing processes. Another significant benefit of the process is that it can be used on highly complex raw materials containing viscera (organs, guts, intestines etc.), or on visceral materials alone to produce high yields oils of unparallel quality and stability compared to other existing processes.

Further examples of the method of this disclosure may include one or more of the following, in any suitable combination.

In examples, a method of extracting oil from biological raw material of this disclosure includes creating a slurry from biological raw material. A pH of the slurry is then raised or lowered to separate lipid and protein components in the slurry. A first lipid rich phase is further separated from a protein rich phase. A pH of the first lipid rich phase is then adjusted to a point at which additional proteins in the first lipid rich phase coagulate. A second lipid rich phase is then recovered from the additional coagulated proteins.

In further examples, creating the slurry includes mixing the biological raw material with water. In examples, further separating the protein and lipid components is performed using one of a decanter, a tricanter, a disc stack centrifuge, a refiner, a press, or a filter. In examples, the biological raw material is one of animal, plant or microbial origin. In examples, the animal is selected from fish, crustaceans, mollusks, echinoderms, land animals, avian animals or insects. In examples, the plant is selected from plants, fungi, plankton, microalgae, or macroalgae. In examples, the microbe is bacteria. In examples, the biological raw material includes whole or different parts of muscle tissue, trimmings, frames, bones, carcasses, skin, heads, brains, hearts, lungs, viscera, guts, livers, kidneys, gallbladders, intestines, gonads, roe or milt. In examples, the biological raw material is fresh, frozen or dried. In examples, the biological raw material is mixed with water at a ratio of 1:0.1 to 1:10, preferably 1:0.5 to 1:3. In examples, a temperature of the slurry is between −2° C. to 100° C., preferably between 0-30° C.

In additional examples, the method further includes heating a temperature of the slurry to 70-100° C. In examples, raising the pH of the slurry includes raising the pH of the slurry to 7-14, preferably to 9-12, with a base or salt. In examples, lowering the pH of the slurry includes lowering the pH of the slurry to 1-5, preferably to pH 1.5-3.5, with an acid or salt. In examples, the base is selected from sodium hydroxide, potassium hydroxide, calcium hydroxide, magnesium hydroxide, carbonate, bicarbonate, ammonium hydroxide and ammonia. In examples, the acid is selected from hydrochloric acid, sulfuric acid, carbonic acid, citric acid, citrate, sorbic acid, sorbate, acetic acid, acetate, lactic acid, phosphoric acid, polyphosphoric acid and amino acids.

In additional examples, the method further includes heating the first lipid rich phase to a temperature between 20-100° C., preferably between 20-50° C. In examples, adjusting the pH of the first lipid rich phase includes adjusting the pH to around isoelectric points of the additional proteins between pH 4-10, preferably between pH 4.5-7.5. In examples, recovering the second lipid rich phase includes recovering the second lipid rich phase in a temperature range of between −2° C. to 100° C., preferably between 20° C. to 60° C.

In additional examples, the method further includes adding di- and/or multivalent cations to the first lipid rich phase. In examples, the di- and/or multi valent cations are selected from magnesium chloride, magnesium acetate, copper chloride, copper acetate, calcium chloride, calcium acetate, calcium lactate, calcium phosphates, calcium tartrate, calcium disodium EDTA, calcium hydroxide, calcium ferrocyanide, calcium silicate, calcium gluconate, calcium guanylate, calcium inosinate, calcium 5′-ribonucleotides, calcium citrate, calcium maleate, calcium benzoate, calcium sulfate, calcium hydrogen sulfate, calcium proprionate, calcium ascorbate, calcium alginate, calcium carbonate, calcium bicarbonate, calcium tartrate, calcium stearoyl-2-lactylate, zinc chloride and zinc acetate. In examples, the di and/or multivalent cations are sourced from one or more of mineral deposits, egg shells, corals, shell fishes, bivalves, algae, microbes, plants, milk, fish and animals. In examples, adding the di- and/or multivalent cations to the first lipid rich phase includes adding the di- and/or multivalent cations at a percentage of 0.001-50%.

In additional examples, the method further includes adding enzymes to the first lipid rich phase. In other examples, the method further includes, after raising the pH of the slurry, further lowering the pH of the slurry, or after lowering the pH of the slurry, further raising the pH of the slurry. In other examples, the method further includes subjecting the second lipid rich phase to one or more of high pressure, low pH, high pH, chemical inactivation, or heat to kill microorganisms.

In further examples, the lipid components include one or more of neutral lipids, non-polar lipids, polar lipids, fatty acids, glycerolipids, glycerol-phospholipids, phospholipids, sphingolipids, saccharolipids, polyketides, sterol lipids, prenol lipids, glycerol and lipid derivatives. In examples, a time period for further separating the lipid and protein components into a first lipid rich phase and a protein rich phase is between <1 min and 10 min. In examples, a time period for further separating the lipid and protein components into a first lipid rich phase and a protein rich phase is between 10 min and 90 min. In examples, a time period for further separating the lipid and protein components into a first lipid rich phase and a protein rich phase is between 90 min and 48 hours.

In additional examples, the method further includes stabilizing the second lipid rich phase with one or more of antioxidants and inert gases. In examples, the method further includes separating a sludge fraction from the first lipid rich phase and the protein rich phase. In examples, the method further includes processing the sludge fraction by one or more of chemical, physical and enzymatic methods to further separate lipid components. In examples, the method further includes processing the first lipid rich phase by one or more of chemical, physical and enzymatic methods to further separate lipid components.

In examples, the method maintains and/or improves an oxidative quality and shelf-life of the second lipid rich phase and protein rich phase. In examples, the second lipid rich phase has p-anisidine values, peroxide values and TOTOX values of <20, <5 mEq and <26, respectively. In examples, the second lipid rich phase has p-anisidine values, peroxide values and TOTOX values of <1, <0.5 mEq and <2, respectively. In examples, the method reduces levels of free fatty acids and/or maintains low levels of free fatty acids in the second lipid rich phase and the protein phase. In examples, the second lipid rich phase includes between <2% and less than <0.1% of fatty acids. In examples, the method reduces environmental toxins and pollutants in the second lipid rich phase. In examples, the method protects, maintains and/or improves functionality of the protein rich phase and the second lipid rich phase. In examples, the method protects, maintains and/or improves color and color stability of the protein rich phase and the second lipid rich phase. In examples, the method protects, maintains and/or improves organoleptic quality of the protein rich phase and the second lipid rich phase. In examples, the method protects, maintains and/or improves bioactive properties of the protein rich phase and the second lipid rich phase. In examples, raising the pH protects the lipid components at warm and high temperatures. In examples, the second lipid rich phase is suitable for use in food, feed, supplements, pharmaceuticals, nutraceuticals, medical devices, therapeutics, and/or cosmetics.

In additional examples, the method further includes adjusting the pH of the first lipid rich phase to around an isoelectric point of the additional proteins in the first lipid rich phase before recovering the second lipid rich phase from the additional coagulated proteins. In examples, the additional coagulated proteins are destabilized by physical, chemical and enzymatic means, allowing additional lipids to be recovered from the additional coagulated proteins.

A reading of the following detailed description and a review of the associated drawings will make apparent the advantages of these and other features. Both the foregoing general description and the following detailed description serve as an explanation only and do not restrict aspects of the disclosure as claimed.

### DETAILED DESCRIPTION

In the following description, the disclosure may describe features in one example, and in the same way or in a similar way in one or more other examples, and/or combined with or instead of the features of the other examples.

In the specification and claims, for the purposes of describing and defining the invention, the terms “about” and “substantially” represent the inherent degree of uncertainty attributed to any quantitative comparison, value, measurement, or other representation. The terms “about” and “substantially” moreover represent the degree by which a quantitative representation may vary from a stated reference without resulting in a change in the basic function of the subject matter at issue. Open-ended terms, such as “comprise,” “include,” and/or plural forms of each, include the listed parts and can include additional parts not listed, while terms such as “and/or” include one or more of the listed parts and combinations of the listed parts.

As used herein, the term “oil” refers to a substance that contains or is made up of lipids.

As used herein, the term “sludge fraction” refers to substances that are not loose lipids or soluble proteins.

As used herein, the term “slurry” refers to a mixture of solids suspended in liquid.

The new method described herein is comprised of several steps.

Initially, biological raw material is chopped, ground, comminuted and/or minced and added to water and is homogenized (for example for 1 sec to 24 hours) to create a slurry. Alternatively, the material can be homogenized directly in water. The raw material to water ratio can vary from 1:0.1 to 1:10, preferably being at 1:0.5-1:3. The water temperature can range from −2° C. to 100° C., preferably being at 0-30° C. The heating to the desired temperature can be done fast (within 1-60 sec), moderately fast (between 1-10 min) or slow (from 10 min to 24 h). The slurry is then adjusted to either low pH (pH 1-5, preferably pH 1.5-3.5) or high pH (pH 7-14, preferably pH 9-12) to solubilize the proteins and release a large fraction of the fat/oil in the slurry. The slurry can sit at the low or high pH for a short (1-60 sec), intermediate (1-30 min) or long (>30 min) time prior to further processing. Any food or feed grade acid or base (liquid, dry or gas form) can be used to adjust the pH of the slurry. This process can be done in a batch or continuous flow system. The pH adjustment can be done fast (within 1-60 sec), at moderate speed (between 1-10 min) or slowly (from 10 min to 24 h). If the pH adjustment is done at 0-30° C., then optionally the slurry can be heated after pH adjustment to 30-100° C., preferably 30-60° C., for improved protein coagulation and oil separation. Surprisingly, the proteins retain high functionality at both high and low pH and high temperature, as they are already unfolded. In some applications, the slurry can be adjusted to low or high pH and then heated to 70-100° C. for a short, intermediate or long time (as outlined above) before separating the oil and protein fraction which results in oil and protein fractions that have higher quality and more stability than the same fractions produced by conventional heating processes.

The pH adjusted (high or low) slurry is then subjected to multi-phase separation to result in two or more fractions. In some applications, this can be a two-phase separation, for example via a centrifuge or decanter, where a protein rich fraction is separated from an oil rich fraction. In some applications, this can be a three-phase separation, for example via a centrifuge, decanter or tricanter, which results in an oil rich fraction, protein rich fraction, and a sludge fraction. In some applications it may be preferable to bring the slurry to a high pH (e.g. 11-12) or low pH (e.g. 2-3) first and then readjust pH to another alkaline or acid pH, e.g. from pH 11-12 to pH 8-9 or pH 2-3 to pH 4-5, before the multi-phase separation process. This may be preferred as it can lead to more stable products that can be more effectively processed in later steps.

The oil rich fraction collected after separation at high or low pH can be collected as-is and further preserved with freezing, refrigeration or other means of stabilizations (e.g. chemical, pressure, irradiation, microbial etc.). Surprisingly, subjecting the slurry to a high pH prior to multi-phase separation has a stabilizing effect on the oil in the oil rich fraction which leads to higher quality oil products. Also, subjecting the slurry to higher or lower pH prior to multi-phase separation gives better oil separation and yields.

The oil rich fraction can be further processed to extract, concentrate and purify the oil in the fraction, resulting in a clean liquid oil that has been stripped of unwanted components which otherwise remain in the oil rich fraction. Prior art pH shift processes result in an oil rich fraction which has significant amount of impurities and is not in a liquid state. Prior art pH shift processes also lead to an oil rich fraction where the oil is not free but emulsified and in a tightly bound state with the proteins and other compounds in the fraction. In some applications, the oil rich fraction recovered at low or high pH can be subjected to heating to increase efficiency of oil extraction, from 30° C. to 100° C., preferably 30-50° C., followed by a centrifugation step, preferably with a disc stack centrifuge. In some applications, the separation produces two oil layers, which can be collected separately and further processed or used as-is.

In some applications, the pH of the oil rich fraction can be adjusted with strong and/or weak acids, bases and/or salts to around the isoelectric points of the proteins in the fraction which induces the proteins to coagulate and separate from the oil in the fraction without having to add enzymes or use high heat. The pH adjustment can be done fast (within 1-60 sec), at moderate speed (between 1-10 min) or slowly (from 10 min to 24 h). The slurry can sit at the low or high pH for a short (1-60 sec), intermediate (1-30 min) or long (>30 min) time prior to further processing. The strong acids and/or bases can be, but are not limited to, hydrochloric acid, acetic acid, phosphoric acid, sodium hydroxide, potassium hydroxide, calcium hydroxide or magnesium hydroxide and can be used at concentrations of 0-100%. The weak acids and/or bases can be, but are not limited to, carbonic acid, bicarbonate, carbonate, citric acid, citrate, sorbic acid, sorbate, acetic acid, acetate, phosphoric acid, polyphosphoric acid or amino acids, and can be used in concentrations of 0-100%. The acids, bases and/or salts can be any food, feed, pharmaceutical, chemical or industrial grade acid, bases and salts available and can be added in liquid and/or dried form. The different salts of the weak acids and/or bases can be sodium, potassium, calcium or magnesium, including other food grade salts. In some applications, amino acids can be used to modify pH. The different amino acids can be glycine, alanine, arginine, serine, threonine or other food grade amino acids, and can be used in concentrations of 0-100%.

If the recovered oil rich fraction is at low pH then it can be adjusted to pH 4-10, preferably around pH 4.5-7.5. If the recovered oil rich fraction is at high pH then it can be adjusted to pH 4-10, preferably around pH 4.5-7.5. The recovered oil rich fraction can sit at the adjusted pH for a short (1-60 sec), intermediate (1-30 min) or long (>30 min) time, prior to separation. The pH shift of the oil rich fraction from high or low pH to the isoelectric points of the proteins is then followed by a separation step to collect and separate a clean, pure liquid oil from the coagulated proteins, for example with a disc stack centrifuge. This protein coagulation step can be effectively accomplished at a wide temperature range, for example from −2° C. to 100° C., but preferably in the low temperature range of 20-60° C. This is a highly innovative step since without adjusting the oil rich fraction to its proteins isoelectric pH the oil would be unable to separate from the proteins at these low temperatures. The protein coagulation breaks the bonds between the oil and the protein allowing the oil to separate at lower temperatures which it would otherwise not do. In some applications the pH adjustment and coagulation can be achieved with di-and/or multivalent cations, with or without the addition of other acids or bases. Examples of di- and/or multivalent cations include, but are not limited to, magnesium chloride, magnesium acetate, copper chloride, copper acetate, calcium chloride, calcium acetate, calcium lactate, calcium phosphates, calcium tartrate, calcium disodium EDTA, calcium hydroxide, calcium ferrocyanide, calcium silicate, calcium gluconate, calcium guanylate, calcium inosinate, calcium 5′-ribonucleotides, calcium citrate, calcium maleate, calcium benzoate, calcium sulfate, calcium hydrogen sulfate, calcium proprionate, calcium ascorbate, calcium alginate, calcium carbonate, calcium bicarbonate, calcium tartrate, calcium stearoyl-2-lactylate, zinc chloride, zinc acetate, to name some examples. In some applications the pH adjustment and coagulation can be achieved with di- and/or multivalent cations from a natural material, for example but not limited to mineral deposit sources, egg shells sources, coral sources, shell fish sources, bivalve sources, algae sources, microbial sources, plant based sources, milk based sources, fish based sources and animal based sources to name a few examples.

The di- and/or multivalent cations can be added at different concentration to the oil rich fraction. In some applications, it may be preferred to add them at a level from 0.001-5%. In some applications, it may be preferred to add them at a level of 5-15%, while in other applications it may be preferable to add them at 15-50. In some applications, a unique combination of citric acid and calcium based ingredients as listed above can be added to the oil rich fraction to synergistically cause an exceptionally strong protein-protein interaction and coagulation, causing very tightly packed protein flocs which lead to an exceptionally high oil recovery %. The di- and/or multivalent cations uniquely act by both affecting pH and causing protein coagulation by cross-linking negatively charged groups on the proteins. Both steps lead to even stronger protein coagulation than using acids and/or bases alone to adjust pH to the proteins isoelectric point. Furthermore, effective protein coagulation can be achieved at pH values away from the proteins isoelectric point, allowing for more process flexibility. Performing the protein coagulation step, either with or without di- and/or multivalent cations, voids the need of any enzymes or high heat and surprisingly gives even better oil separation and recovery than using enzymes and also at lower temperatures than current commercial processes, giving an oil of exceptional purity, quality and stability. This step is distinctly different from prior art pH shift processes which pH shifts the protein fraction recovered at high or low pH but not the oil rich fraction which is separated from the protein fraction. The oil separated from the oil rich fraction with the protein coagulation step still has as high stability as the oil separated at high pH. The oil separated from the oil rich fraction with the protein coagulation step is also lower than traditionally extracted oil in environmental toxins and pollutants, such as heavy metals, arseonolipid compounds, dioxin, PCBs etc., avoiding the need for harsh post processing methods. Furthermore, the oil separated with this method from aquatic raw materials rich in astaxanthin has a strong and favorable pigmentation due to astaxanthin pigments that are co-extracted with the oil and are stabilized due to the mild process. Surprisingly, oil extracted from heads of fish species rich in astaxanthin, has a strong red/orange pigmentation in contrast to oil that is extracted with the harsher commercial processes where the oil has a yellowish color.

In some applications, it may be preferred to process the raw material (chopped, ground, comminuted and/or minced and added to water and homogenized) at low pH (1-5), followed by separation into an oil rich phase and a protein rich phase. The protein rich phase can be processed further into a protein concentrate or dried protein product for various different applications, including, but not limited to, food, feed and fertilizer. The low pH oil rich fraction can be adjusted to a high pH (7-14) with the addition of strong and/or weak bases, followed by separation to recover a stable oil fraction. In another version of the process, it may be preferred to add di- and/or multivalent cations prior to, during or after the addition of strong and/or weak bases. In another version of the process, the low pH oil rich fraction can be heated prior to or after the addition of strong and/or weak bases, in the presence or absence of di- and/or multivalent cations. In some applications, it may be preferred to adjust the oil rich fraction in the abovementioned examples to a pH around the isoelectric point of the proteins in the oil rich phase, followed by separation to recover a stable oil fraction.

In some applications, the process can be used to improve the quality and stability of oils produced from conventional processes. In one version of the process, the heated slurry of a conventional process can be combined with a strong and/or a weak base (with and without water), with or without the addition of di- and/or multivalent cations. The oil can then be separated from the slurry. In another version of the process, an extracted oil from another process can be subjected to a high pH (7-14) wash, where the pH is reached with strong bases and/or weak bases, and then followed by oil separation.

In some applications, the process can be used to separate and/or isolate any immiscible components and/or phases derived from any biological raw material of animal, plant or microbial origin with the aim to increase the quality and stability of the extracted/isolated components and/or phases, compared to conventional separation and/or isolation methods. In some application it may be preferred to use the process at low temperatures and optimal pH to separate and/or isolate the immiscible components and/or phases, to yield the highest quality extracted/isolated components and/or phases. In some applications it may be preferred to use di- and/or multivalent cations in addition to low temperature and optimal pH to separate and/or isolate the immiscible components and/or phases, to yield the highest quality extracted/isolated components and/or phases. For example, the process can be used to separate and/or isolate components of different polarity from a variety of biological raw materials to yield extracts/compounds/isolates of higher purity, quality and bioactivity than using conventional separation methods. For example, the process can be used to separate and/or isolate phospholipid components from a variety of biological raw materials to yield extracts/compounds/isolates of higher purity, quality and bioactivity than using conventional separation methods. For example, the process can be used to separate and/or isolate lipid components from a variety of biological raw materials to yield extracts/compounds/isolates of higher purity, quality and bioactivity than using conventional separation methods. For example, the process can be used to separate and/or isolate protein components from a variety of biological raw materials to yield extracts/compounds/isolates of higher purity, quality and bioactivity than using conventional separation methods. For example, the process can be used to separate and/or isolate bile components from gallbladders to yield a bile extract/compound/isolate of higher purity, quality and bioactivity than using conventional separation and/or isolation methods.

In some applications, after separating the oil or lipids from the proteins in the oil rich fraction, there may be a residual phase containing additional coagulated proteins. In some applications, the residual phase (i.e. the additional coagulated proteins) can be subjected to chemical, physical or enzymatic methods to further extract lipid components from it.

In some applications, it may be preferable to add proteolytic enzymes to the oil rich fraction collected after separation at high or low pH (or added to one or both oil layers recovered after oil separation with a centrifuge) to further increase the efficiency of oil extraction by breaking protein-oil and protein-protein bonds. In some applications, the enzymes can be added to the oil rich fraction at high or low pH. In some applications, the enzymes can be added to the oil rich fraction after its pH has been adjusted to the isoelectric point of the proteins in the oil rich fraction. In some applications, the enzymes can be added to the oil rich fraction before or after addition of di- and/or multivalent cations. In some applications, the oil rich fraction with added enzymes can be adjusted to a pH range where the enzymes have the most activity. This is particularly the case for raw materials where there are very strong protein-oil and protein-protein bonds. The enzymes can be added at a ratio of 1:1000 to 1:1 enzyme to protein substrate (weight to weight) ratio, preferably at 1:200 to 1:20 ratio. In contrast to current commercial enzyme processes the new pH shift process uses significantly less amounts of enzymes since it is processing a much lower volume of raw material, or from 10-100 times less, resulting in greatly lower costs. The oil rich fraction with added enzymes is heated to the optimal temperature range of the enzyme used. In some applications, the temperature may be from −2° C. to 30° C., from 30° C. to 50° C., from 50° C. to 70° C., from 70° C. to 100° C. In some applications, cold adapted enzymes can be used, while in other applications enzymes adapted to moderate and high temperatures can be used. In some applications, alkaline proteases can be used, while in other applications acid proteases or neutral proteases can be used. Surprisingly, running the enzymatic hydrolysis at alkaline pH leads to a higher quality and more stable oil product compared to current enzyme processes as well as more efficient separation and higher yields at reasonably low temperatures. In some applications, extremophile enzymes adapted to extreme temperatures, pH and pressures can be used. In some applications, the enzyme reaction is run for different amounts of time, for example <1 min, 1-10 min, 10-30 min, 30-60 min, 60-90 min, 90 min to 48 hours. After enzymatic hydrolysis, the enzymes can be inactivated with high temperatures (e.g. 50-100° C.), high pressures (e.g. 300-600 MPa), low pH (e.g. pH 1-3) or high pH (e.g. 11-13), chemical inactivation or with a combination of inactivation methods. In some applications, it is not necessary to inactivate the enzymes as they are not carried over into the oil, leading to significant savings in processing costs. In some applications, the oil is recovered after enzyme hydrolysis with a separation step, preferably centrifugation and preferably disc stack centrifugation. In some application, the oil is recovered after hydrolysis, but prior to enzyme inactivation, with a separation step and then the hydrolyzed protein fraction which is separated from the oil is subjected to an enzyme inactivation step. In some applications, the protein containing fraction that is separated from the oil rich fraction after enzyme processing can be recovered and further processed as described for the protein rich fraction above. In some applications, where enzyme inactivation is not applied, the protein containing fraction that is separated from the oil rich fraction and contains active enzymes can be added to a new batch of oil rich fraction to reduce enzyme costs.

In some applications, the recovered oil (enzymatically processed or not) is cooled to −10° C. −30° C. after recovery. In some applications, the recovered oil is further processed with chemical, physical and/or enzymatic methods to concentrate polyunsaturated fatty acids or interest. These methods include but are not limited to fractionation, filtration, chromatography, low temperature fractional crystallization, chemical esterification, enzymatic esterification, molecular distillation, supercritical fluid extraction, chemical condensation, enzymatic condensation, urea adduction, etc. In some applications, the recovered oil can be purified to remove undesirable compounds, for example but not limited to with filtration (e.g. clay or charcoal), distillation etc. In some applications, the recovered oil can be stabilized with natural and synthetic antioxidants, inert gases including but not limited to nitrogen, argon, carbon dioxide etc. In some applications, the recovered oil is rich enough in natural antioxidants and does not require addition of natural or synthetic antioxidants. In some applications, lower amounts of added natural or synthetic antioxidants can be added than are added to oils extracted with standard processes. In some applications, the recovered oil or oil rich fraction, is subjected to high heat to kill microorganisms that may be present. Surprisingly, the oil or oil rich fraction recovered with this new process does not degrade the oil, unlike oils from conventional processes. In some applications, strong bases and/or weak bases are added to the oil or are added and then removed from the oil for even increased stability.

Tests show that the fish oils extracted using this new method have far lower oxidation values than oils processed with current technologies and much higher stability. For example, oil extracted from either salmon or mackerel with either the enzyme-assisted or isoelectric pH coagulation assisted methods had the following oxidation values: p-anisidine of <0.5, peroxide value of <0.1 mEq/kg and TOTOX of <0.5. Fish oils extracted with current technologies commonly have values that are around or even exceed the recommended p-anisidine, peroxide values and TOTOX values of 20, 5 mEq/kg and 26, respectively. Furthermore, the oils extracted with the enzyme assisted or isoelectric pH coagulation assisted methods have virtually no free fatty acids (<0.05%), another quality indicator, which remains very low during storage. Oils extracted with current technologies can have free fatty acids in double digit percentages. In some applications, the process can be applied to raw materials and/or oils that already have a significant level of free fatty acids and result in an oil with significantly reduced or no measurable levels of free fatty acids.

The protein rich fraction recovered after separation is adjusted to pH 4-7, preferably 5-6, which causes strong protein-protein interactions and protein coagulation. Any food or feed grade acid or base (liquid, dry or gas form) can be used to readjust the pH of the slurry. If the temperature of the slurry prior to pH adjustment to 4-7 was at −2-30° C., then protein coagulation can be assisted by heating the slurry to 30-100° C., preferably 30-60° C. Surprisingly this not only greatly enhances protein coagulation and protein recovery by creating bigger protein flocs, but the proteins also retain high functionality. Protein coagulation can also be assisted by adding di- and/or multivalent cations to the slurry, with or without heating and can be done over a wider pH range than without the di- and/or multivalent cations, or pH 3-10, preferably from pH 4-9. The process of first adjusting the raw material slurry to a high pH prior to separation and then coagulation of the proteins leads to recovered proteins of higher stability, better quality and better functionality, including better separations and yields. The coagulated proteins are then recovered and concentrated, which can be done with several different separation methods, included but not limited to screening, mechanical screening/refining, ultrasound, electrocoagulation, dissolved air flotation, filtration, pressing and centrifugation. In some applications, the protein fraction can be recovered and preserved as-is with freezing, refrigeration or other means of stabilizations (e.g. chemical, pressure, irradiation, microbial etc.). In some applications, the process to recover the proteins in the protein rich fraction can be applied to wastewater and/or washwater containing proteins at a range of concentrations (0.1-50%). Proteins recovered from different parts of the raw materials have different functionalities after undergoing the pH-shift process which increases the number of applications for the proteins compared to proteins that are recovered with conventional processes which have very limited functionalities and applications. In some applications, the recovered protein can be further processed, including but not limited to hydrolysis, fractionation, heating, pasteurization, pressurization, concentration, drying etc. In some applications, the protein fraction can be used in food applications. In other applications, the protein fraction can be used in feed and pet food applications or as a fertilizer.

The sludge fraction can be recovered and preserved as-is with freezing, refrigeration or other means of stabilizations (e.g. chemical, pressure, irradiation, microbial etc.). In other applications, the sludge fraction can be recovered and preserved by concentrating it with heat, preferably under vacuum, and then either dried (spray dried, air dried, freeze dried, film dried etc.) or stabilized by freezing, refrigeration or by other means of stabilization (e.g. chemical, pressure, irradiation, microbial etc.). In some applications the sludge fraction can be processed further via chemical or enzymatic hydrolysis. In some applications, phospholipids or a phospholipid rich fraction can be recovered from the sludge which can be further processed into various different products and applications. In some applications, the sludge fraction can be used in food applications. In other applications, the sludge fraction can be used in feed and pet food applications. In other applications, the sludge fraction can be used as a fertilizer.

While the disclosure particularly describes preferred examples, those skilled in the art will understand that various changes in form and details may exist without departing from the spirit and scope of the present application as defined by the appended claims. The scope of this present application intends to cover such variations. As such, the foregoing description of examples of the present application does not intend to limit the full scope conveyed by the appended claims.

1-48. (canceled)

49. A method of extracting oil from biological raw material, the method comprising:
creating a slurry from biological raw material wherein creating the slurry comprises mixing the biological raw material with water at a ratio of 1:01-1:10 preferably 1:0.5 to 1:3;
raising or lowering a pH of the slurry to separate lipid and protein components in the slurry;
further separating a first lipid rich phase from a protein rich phase;
adjusting a pH of the first lipid rich phase to a point at which additional proteins in the first lipid rich phase coagulate;
and recovering a second lipid rich phase from the additional coagulated proteins.

50. The method of claim 1, wherein further separating the protein and lipid components is performed using one of a decanter, a tricanter, a disc stack centrifuge, a refiner, a press, or a filter.

51. The method of claim 1, wherein the animal is selected from fish, crustaceans, mollusks, echinoderms, land animals, avian animals or insects.

52. The method of claim 1, wherein the biological raw material comprises whole or different parts of muscle tissue, trimmings, frames, bones, carcasses, skin, heads, brains, hearts, lungs, viscera, guts, livers, kidneys, gallbladders, intestines, gonads, roe or milt.

53. The method of claim 1, wherein a temperature of the slurry is between −2° C. to 100° C., preferably between 0-30° C.

54. The method of claim 1, wherein raising the pH of the slurry comprises raising the pH of the slurry to 7-14, preferably to 9-12, with a base or salt.

55. The method of claim 1, wherein lowering the pH of the slurry comprises lowering the pH of the slurry to 1-5, preferably to pH 1.5-3.5, with an acid or salt.

56. The method of claim 1, further comprising heating the first lipid rich phase to a temperature between 20-100° C., preferably between 20-50° C.

57. The method of claim 1, wherein adjusting the pH of the first lipid rich phase comprises adjusting the pH to around isoelectric points of the additional proteins between pH 4-10, preferably between pH 4.5-8.5.

58. The method of claim 1, wherein recovering the second lipid rich phase comprises recovering the second lipid rich phase in a temperature range of between −2° C. to 100° C., preferably between 20° C. to 60° C.

59. The method of claim 1, further comprising adding di- and/or multivalent cations to the slurry, protein rich phase, first and second lipid rich phase, such as, but not limited to magnesium chloride, magnesium acetate, calcium chloride, calcium acetate, calcium lactate, calcium phosphates, calcium tartrate, calcium hydroxide, calcium silicate, calcium gluconate, calcium guanylate, calcium inosinate, calcium citrate, calcium maleate, calcium benzoate, calcium sulfate, calcium hydrogen sulfate, calcium proprionate, calcium ascorbate, calcium alginate, calcium carbonate, calcium bicarbonate, calcium tartrate.

60. The method of claim 1, wherein a time period for further separating the lipid and protein components into a first lipid rich phase and a protein rich phase is between <1 min and 90 min.

61. The method of claim 1, further comprising stabilizing the second lipid rich phase with one or more of antioxidants and inert gases.

62. The method of claim 1, further comprising processing the first lipid rich phase by one or more of chemical, physical and enzymatic methods to further separate lipid components.

63. The method of claim 1, wherein the second lipid rich phase has p-anisidine values, peroxide values, TOTOX values and acid values of <20, <5 mEq, <26 and <8 respectively.

64. The method of claim 1, wherein the method reduces environmental toxins and pollutants in the second lipid rich phase.

65. The method of claim 1, where the biological raw material slurry can be wastewater and/or washwater with a protein content between 0.1-50%, preferably between 0.1-5%.

66. The method of claim 1, wherein proteins in the pH adjusted slurry and/or protein rich fraction is aggregated, coagulated, and/or flocculated into bigger protein flocks by adjusting pH to 4-11, preferably pH 4-9, at −2-60° C., preferably at −2-30° C., using acids, bases, di- and/or multivalent cations, alone or in different combinations, with or without temperature adjustment and then recovered with or without further concentration and/or separation.
